(19) United States
(12) Patent Application Publication
(10) Pub. No.: US 2013/0159084 A1
(43) Pub. Date: Jun. 20, 2013

(54) LOYALTY AND REWARD PROGRAM AND METHOD TO INCENT PARTICIPANTS

(71) Applicant: INCENTCO LLC, Naperville, IL (US)

(72) Inventors: Greg Smith, Naperville, IL (US); Gerry Wiatrowski, Napervile, IL (US)

(73) Assignee: INCENTCO LLC, Naperville, IL (US)

(21) Appl. No.: 13/666,624

(22) Filed: Nov. 1, 2012

Related U.S. Application Data
(60) Provisional application No. 61/554,368, filed on Nov. 1, 2011.

(51) Int. Cl. G06Q 30/02

(52) U.S. Cl. CPC G06Q 30/0226
USPC 705/14.27

(57) ABSTRACT

A method of providing rewards to a first party is shown and described. The method may include, the steps of providing a loyalty award Internet website, purchasing a plurality of promotional codes, where the plurality of promotional codes are redeemable from a plurality of merchants, storing the plurality of promotional codes within the loyalty award website, and allowing an award to be granted to the first party by a second party through the loyalty award website, the award having a preselected amount, wherein the first party may obtain at least one of the promotional codes stored in the loyalty award website, whereby an amount of the promotional code obtained is related to the amount of the award. The method may also include the steps of automatically generating a notification to the first party from the loyalty award website, where the notification includes a link to the award, and allowing redemption of at least a portion of the amount of the promotional code through the loyalty and award program.

### CROSS-REFERENCE TO RELATED APPLICATION

This application claims the benefit from U.S. Provisional Patent Application No. 61/554,368 entitled “Loyalty and Reward Program and System to Incent Participants” filed on Nov. 1, 2011, which is hereby incorporated in its entirety by reference.

### FIELD OF THE INVENTION

This application relates to a loyalty program and more particularly to a loyalty and reward program and method to incent participants.

### BACKGROUND

Competition among businesses is ever increasing, especially among retailers and service providers. Businesses are constantly trying to incentivize desired behaviors among their employees, clients and customers. There are many available incentive programs that attempt to drive these beneficial behaviors. Many of these businesses use reward programs to obtain and gain customer loyalty in an effort to maintain and grow their businesses. These reward programs take all kinds of forms and provide a wide variety of features and components. Most reward programs attempt to provide some kind of incentive to clients and customers to return to the particular business, make purchases before deadlines, or the like—i.e., they attempt to drive certain favorable behaviors.

There are a number of different reward programs available to consumers and users of services. These reward programs typically reward a purchaser of a particular good or service or reward purchases from a particular retailer or service provider. Most of these reward programs, however, are only single use programs that are specific to their original industry or application to which they apply. They are inflexible and are not capable of being customized for utilization in other fields of use, industries, and applications. They are only capable of driving a single behavior.

Similarly employers use incentive programs to drive certain behaviors among its employees. As competition among employers for quality-qualified employees is increasing, employers are becoming more creative with the available benefits while attempting to control costs. This has lead to creation of certain employee incentive programs. Employers also strive to develop programs that incent certain behaviors among their employees, e.g., participation in wellness programs and the like. Employers are beginning to use reward programs similar to those already offered by retailers and service providers.

There are, however, still many industries that do not utilize organized incentive programs. For example, there are few if any incentive programs available to the U.S. multi-family real estate market. The U.S. multi-family real estate market represents 15% of the U.S. population, comprising over $1.5 trillion of invested capital. In 2010, the 50 largest apartment owners in the U.S. will have given over $1 billion in gifts and concessions to renters. However, unlike most industries, there are no rewards or loyalty programs targeted at the multi-family consumer. Giving a “gift” or incentive to apartment residents is a standard business practices in which over 80% of all real estate professionals participate.

Despite the unavailability of such organized incentive programs, residents expect incentives for new leases, lease renewals, lease referrals and a variety of other events. Apartment owners and operators offer concessions, merchandise, gift cards, and in-unit upgrades as part of their own incentive programs. However, these incentive programs are ad hoc and are not typically applied in a rules oriented and consistent manner. Further, $1 spent on rent concessions or gifts results in a loss of $1 in margin to the owner, but may not result in $1 of value to the resident. Direct rent concessions or one-time gifts consume staff time and yield short-term results that are hard to quantify with no incentive for long-term consumer loyalty.

Further, no platform exists to provide a strategic management tool to promote positive resident behaviors and resident satisfaction. Still further, no platform exists that provides valuable gifts of local and national merchant discount offers and community information to each new renter.

The lack of such available programs, however, is not limited to the multi-family residential real estate market, many other industries and fields of use have a need for such programs, but none are available. Similar to the multi-family residential real estate market, there are few if any commercially available programs available to incentive programs for employees, such as employee benefit programs. The loyalty and rewards industry offers very few options for a turnkey incentive solution that provides businesses of any size and across a variety of industries, an incentive solution that is: cost effective, easy to use, completely web-based, automated, private-label ready, consumer engaging with a real-time redemption process and unlimited reward choices, and provides real time data and program results.

Therefore, there is a need for a commercially available platform that harnesses the efficiencies and transparency of technology and the purchasing power of available business partners to provide meaningful incentives to users while generating revenue for the provider. There is also a need for an incentive program available for use in a variety of fields of use and customizable to provide an appropriate incentive program. Further still, there is a need for turnkey incentive solution that provides businesses of any size and across a variety of industries, an incentive solution that is: cost effective, easy to use, completely web-based, automated, private-label ready, consumer engaging with a real-time redemption process and unlimited reward choices, and provides real time data and program results.

### SUMMARY

A method of providing rewards to a first party is shown and described. The method may include, the steps of providing a loyalty award Internet website, purchasing a plurality of promotional codes, where the plurality of promotional codes are redeemable from a plurality of merchants, storing the plurality of promotional codes within the loyalty award website, and allowing an award to be granted to the first party by a second party through the loyalty award website, the award having a preselected amount, wherein the first party may obtain at least one of the promotional codes stored in the loyalty award website, whereby an amount of the promotional code obtained is related to the amount of the award. The method may also include the steps of automatically generating a notification to the first party from the loyalty award website, where the notification includes a link to the award, and allowing redemption of at least a portion of the amount of the promotional code through the loyalty and award program.

A method of providing rewards to a user may include the steps of accessing a loyalty award Internet website by a first party, making an award to the user by the first party through the loyalty and reward website, and notifying the user of the award. The method may also include the steps of allowing access to a plurality of promotional codes stored within the loyalty award website, and allowing redemption of the award for at least one of the plurality of promotional codes through the loyalty award website.

A method of providing rewards to a user may include the steps of providing a loyalty award Internet website, acquiring a plurality of promotional codes, and storing the promotional codes within the loyalty award website, wherein the plurality of promotional codes are redeemable from a plurality of merchants. The method may also include the steps of providing access to the loyalty award website by a first party, permitting the first party to make an award to the user through the loyalty award website, where the award is redeemable by the user for at least one of the promotional codes, and providing an alert to the user to redeem the award for the at least one of the promotional codes through the loyalty and award program.

### BRIEF DESCRIPTION OF THE DRAWINGS

Operation of the invention may be better understood by reference to the following detailed description taken in connection with the following illustrations, wherein:

FIG. 1 is a schematical representation of a method of operating a loyalty and reward program.

FIG. 2 is an exemplary screen shot of a website depicting awarding of a reward as part of the loyalty and reward program.

FIG. 3 is an exemplary screen shot of the website depicting requesting information for awarding rewards as part of the loyalty and reward program.

FIG. 4 is an exemplary screen shot of the website depicting an award received as part of the loyalty and reward program.

FIG. 5 is an exemplary screen shot of the website depicting a login page for a recipient of an award of the loyalty and reward program.

FIG. 6 is an exemplary screen shot of the website depicting a registered recipient as part of the loyalty and reward program.

FIG. 7 is an exemplary screen shot of the website depicting a recipient redeeming the reward of the loyalty and reward program.

FIG. 8 is an exemplary screen shot of the website depicting a redeemed reward of the loyalty and reward program.

FIG. 9 is an exemplary screen shot of the home page of the loyalty and reward program.

FIG. 10 is an exemplary screen shot of a manager login webpage of the loyalty and reward program.

FIG. 11 is an exemplary screen shot of a dashboard of a webpage of the loyalty and reward program.

FIG. 12 is an exemplary screen shot of an administrative webpage of the loyalty and reward program.

FIG. 13 is an exemplary screen shot of a data entry webpage of the loyalty and reward program.

FIG. 14 is an exemplary screen shot of customization of settings within the loyalty and reward program.

FIG. 15 is an exemplary screen shot of a manager assigning an activity to an individual within the loyalty and reward program.

FIG. 16 is exemplary screen shots of a resident sign-up process of the loyalty and reward program.

FIG. 17 is exemplary screen shots of the resident activation process of the loyalty and reward program.

FIG. 18 is an exemplary screen shot of an individual resident home page of the loyalty and reward program.

FIG. 19 is exemplary screen shots of award redemption of the loyalty and reward program.

FIG. 20 is exemplary screen shots of the award redemption of the loyalty and reward program.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

Shown in the accompanying drawings an incentive program is shown that includes at least one of the following characteristics: is cost effective, easy to use, web-based, automated, private-label ready, consumer engaging with a real-time redemption process, flexibility of reward choices, and provides real time data and program results. The incentive program may be capable of being used in any appropriate field of use to drive the applicable behavior desired by the user of such program. While the present disclosure may disclose the incentive program for certain fields of use, it should be understood that the incentive program may be used in any appropriate field of use and the present teachings are not limited to those fields of use shown and described herein. These are merely exemplary embodiments of the incentive program.

In some embodiments of the incentive program, the user may utilize the incentive program as a loyalty and reward program and system to incent participants to accomplish certain behaviors. The loyalty and reward program may be a strategic, automated and integrated rewards program that can be used within any applicable field of use, including, without limitation multi-family industry or benefit programs. In some embodiments, residents/users may be rewarded with grants of points for property specific activities or events, which may be redeemed for goods and services at national and local brand name merchants and for services offered by the provider of the program, such as the apartment community. The activities for which rewards may be provided can be any sort of activity, including, without limitation on-line or off-line activities, activities related to purchases or performance, or team or individual events. Data may be gathered on-line automatically or manually with a manual award entry process to make awards.

The loyalty and reward program may include a platform developed utilizing at least one of hypertext preprocessor language (“PHP”), JavaScript and SQL Database structures. The PHP, JavaScript and SQL Database structures may be open source code, which may provide flexibility for future enhancements and ease of use—but are not limited to being open source. The platform may be formed from any suitable software language, especially one capable of being used via the Internet. The platform may be fully customizable and adaptable to the functional needs of a variety of users. The platform may be heavily automated to ensure scalability for large volume users while also being managed at the individual level. The loyalty and reward program may be used to reward users in an effort to create loyalty while generating valuable ancillary income stream of approximately 10% or more on every incentive dollar spent by participating users.

The loyalty and reward program may also include any appropriate reporting structures. These reporting structures may be implemented to allow the user and its administrator to have easy insights into the activities within the platform. The platform may be hosted in a data center within a predetermined location with real time redundancy, support and full remote disaster backup and recovery capabilities in the same or different predetermined location.

From the user and consumer perspective the platform may be highly developed for ease of use. The platform setup and customization may be quickly and easily accomplished by the provider as necessary for the utilization thereof. Training for the loyalty and reward program may be done on line, in an online seminar session, in person, or as otherwise may be appropriate. Further, administering the loyalty and reward program as a point and click system may allow for and provide awards efficiently and allow the user to check on progress of the awards.

The user or the provider may direct the consumer in use of the loyalty and reward program use so that he or she can check the point balances and values within the consumer's account. Further, the user or provider may train the consumer on how to shop and redeem points or awards for codes to make purchases in the online shopping portion of the loyalty and reward program. The loyalty and reward program may be very stable and well supported by the provider or even under certain circumstances by the user.

The provider may operate the loyalty and reward program with a defined strategy for the selection of merchant partners that may provide the products or services that the consumers may desire to purchase with applicable gift codes. For example, the loyalty and reward program may provide users and providers with high quality nationally known enterprises that offer hundreds of brands and thousands of products. Providers or users may also participate as a merchant within the loyalty and reward program, offering their own products or services either within their own customized platform or within a generally available platform. The loyalty and reward program may be structured to allow for the addition of merchants, such as when demand and volume grow. Further, the loyalty and reward program may provide a diversity of shopping choices.

The loyalty and reward program may include inventories of electronic gift certificates or codes issued by merchants, and provide a wide range of values so that consumers may have a good selection from which to choose to redeem their points. In some embodiments of the loyalty and reward program, users may not have to wait for extended periods of time to build enough value to be able to redeem their points. They may be able to redeem points/awards for codes for a predetermined amount, such as being worth as little as $10, if they wish and apply the code towards part of the cost of an item. This may provide flexibility and personal preferences to users and providers so that users may redeem their points for what they want, when they want it. Further, the loyalty and reward program may allow the provider or user to award categories and point values set by certain pre-determined characteristics, including, without limitation by region, property, employer, facility and the like.

The loyalty and reward program may allow the user and provider to share in revenue garnered from discounts earned on the purchase of promotional codes, e.g., virtual gift cards and the expiration of the unredeemed points. Users may make payment to the provider for initial set-up fees, ongoing monthly administration fees, the purchase of award points, or any other appropriate amounts set by the provider. In some embodiments, every incentive given to a consumer may be at a dollar for dollar expense for the user. In the gift card/promotional code world of e-commerce, the actual costs are dependent upon discounts and redemption levels. Users may also benefit from a share of commissions generated on websites that may be associated with the loyalty and reward program. Users may benefit from the shared revenue stream, an effective and efficient strategic platform for granting incentives, enhanced budget control, on-site labor savings and the ability to create a more positive experience with the consumer by having a value proposition that may promote loyalty.

Further, the loyalty and reward program may be designed to be a limited scope plan to grant awards to consumers and allow them to select the specific merchandise or services they wish through the use of gift codes drawn from the applicable inventory. The inventory of the gift codes may be pre-purchased by the provider from merchant partners or others. The loyalty and reward program may require only the establishment of an account with the provider and may not require extensive IT involvement or data exchange between the provider and user. This may be accomplished by providing the loyalty and reward program entirely on-line such as through an Internet website. The user and recipient may utilize and operate the loyalty and reward program online through a public or private website. The functionality may also be provided online. By way of a non-limiting example, the provider, user or recipient may use the loyalty and reward program online to perform the functions mentioned in this disclosure, which may include customizations, communications, processing of awards and recipients and the like.

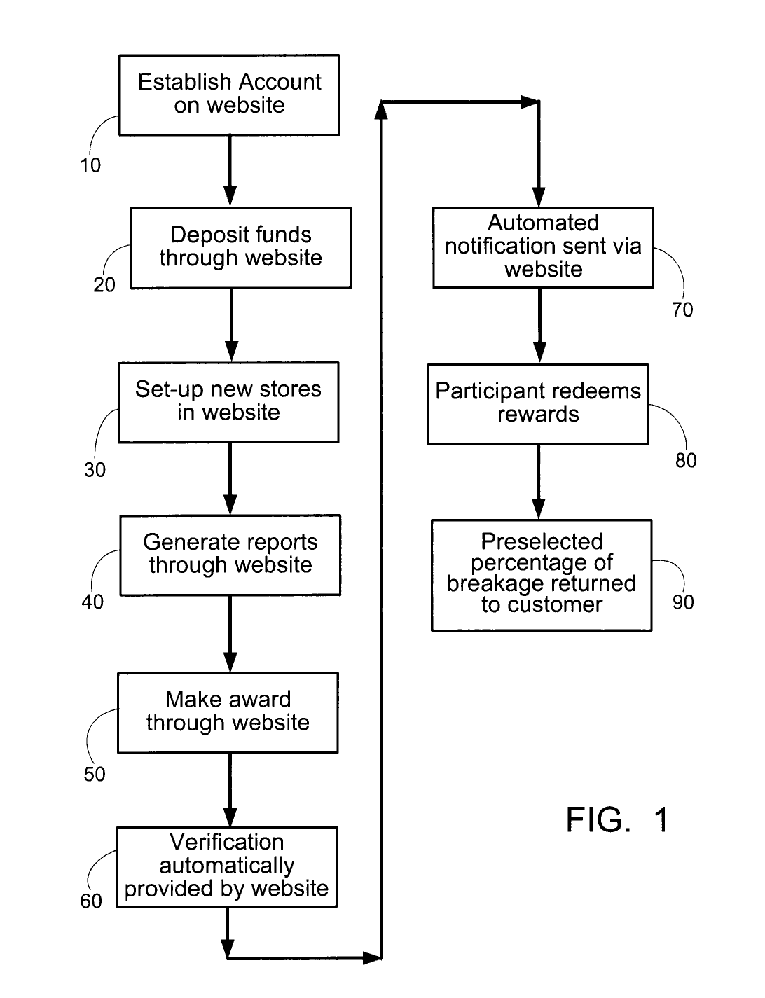

The user may, such as through an administrator, establish an account under the loyalty and reward program offered by the provider 10, such as shown in FIG. 1. The user or provider may place a link to a panel, which may be appropriately branded for the provider, user or both, on an applicable location, such as on the corporate web site of the provider or user. The provider or user may utilize a link to an Internet website so as to limit IT involvement and provide a more efficient program.

In some embodiments, the user may need to acquire appropriate identification, such as the email addresses, of consumers to whom they wish to grant awards. By way of a non-limiting example, the user may target those events for which they now give some concession, gift card, gift basket, etc. The loyalty and reward program may be positioned to replace the time and effort now involved in providing these concessionary gifts.

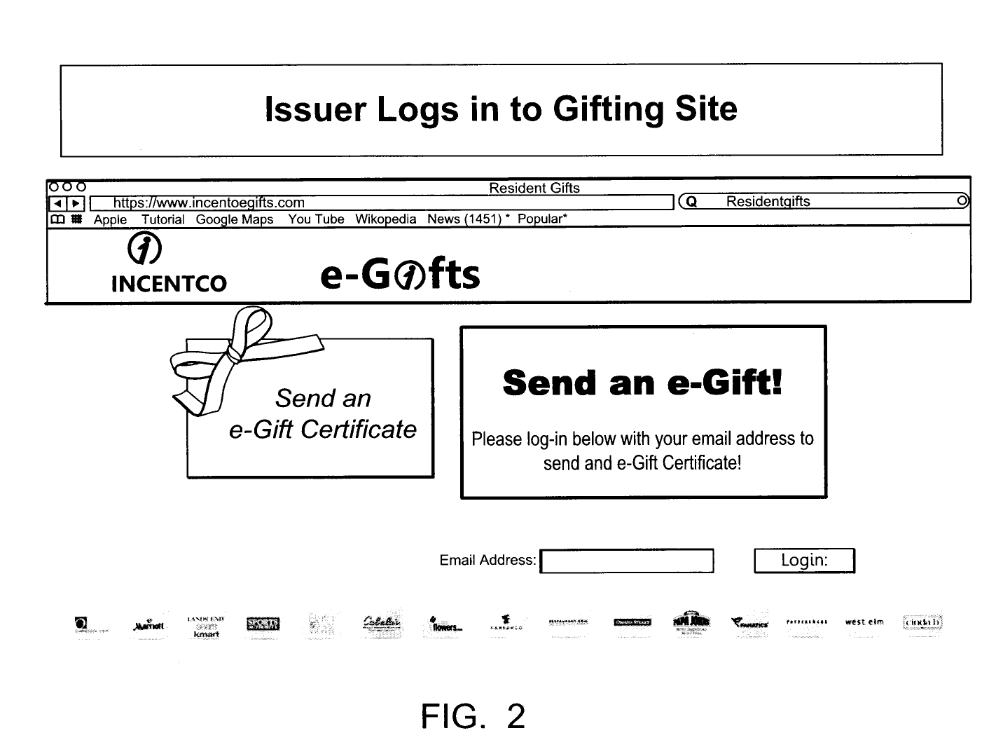

The user may then deposit funds with the provider upon which the user may draw to issue awards 20, such as shown in FIG. 2. This may be done through an Internet website of the loyalty and reward program. The user may make periodic deposits, such as monthly, or based upon predetermined account balances, such as online through the loyalty and reward program. Further, the loyalty and reward program may allow awards to be granted to a consumer by a user, such as a manager of the user up to the balance of funds in the account. The loyalty reward program may advise the user when its balance drops below an amount, which may be determined by the user or provider. By way of a non-limiting example, an e-mail, text message or the like may be automatically generated or one may be sent manually through the loyalty and reward program. This may allow the user to replenish its account as appropriate. Otherwise, the user may not be allowed to exceed the funds available in its account.

The transfer of funds into the account may be accomplished in any appropriate manner, including, without limitation through ACH or wire transfer through the loyalty and reward program. Additionally a user may elect to use a credit card—which may require establishment of a service charge process to cover the costs—this may be done at the discretion of the provider.

An administrator of either the provider or user may be able to create new “stores”, establishing manager credentials, e.g., user name, and password, within the loyalty and reward program 30 website. This may allow for certain customizations to the provider or user. The administrator may also be able to activate and deactivate stores—further providing certain customizations within the loyalty and reward program. This may be accomplished online with the loyalty and reward program being an Internet website.

The loyalty and reward program may generate reports based on any appropriate characteristics within the loyalty and reward program 40. By way of a non-limiting example, reports may be created using the loyalty and reward program for viewing at a store level by managers and also at both a store and portfolio level by administrators. The reports may include any appropriate information, including, without limitation: balance of deposit in account, active and inactive stores, awards by store and portfolio by month, quarter and year with year-to-date data or the like. The reports may be automatically generated by the loyalty and reward program or manually through the loyalty and reward program. Similarly, the reports may be sent through or may be stored within the loyalty and reward program. The provider, user or recipient may be able to access these reports any time they access the loyalty and reward program.

As previously noted, the loyalty and reward program may allow for an award to be made by the user to the consumer 50. In some embodiments, to make an award to a consumer, the user—such as the user manager—may log onto the user's account for their store and click on a predetermined link, such as one entitled “Make an Award”. Once completed, a screen may pop up and the user manager may enter the applicable details including, without limitation: consumer name, consumer email, amount, award event type, message and the like. The user may then click “Send” and the loyalty and reward program initiates the award. This may be done online through the loyalty and reward program.

The loyalty and reward program may then confirm the balance in the user's account. This may automatically occur when the user attempts to send the award 60. If the user has the appropriate amount of funds within its account, the loyalty and reward program may provide an onscreen verification to the user that the award has been sent. If, however, the user does not possess the appropriate amount of funds, the loyalty and reward program may reject the award such as, with a “red pop up” to alert the user. The indications of actions or inactions from the loyalty and reward program may be sent to a predetermined user contact, such as a user manager named by the user in setting up its account.

If there are sufficient funds the loyalty and reward program may automatically generate an email to the consumer notifying him or her of the award 70. The email may contain an award certificate or any appropriate indication of the award. By way of a non-limiting example, the award certificate may also contain: branded header for the applicable user, copy advising the consumer of the award, an explanation that the award is being handled through the provider, thank you message, award amount, which may be expressed as “points with a value of $xx,” directions for redeeming the points and a link to the provider's website.

Further, the notification may include login details that include a unique consumer identification or validation code. The identification or validation code may be generated by the provider or automatically through the loyalty and reward program. The notification may also include details regarding the expiration date of the points/award, such as at the end of the next calendar year. If the consumer does not redeem the points/award by the expiration date, the amount may be shared between the provider and user. Further, the loyalty and reward program may be customized to alert consumers that they may go on the provider website any time until the expiration date to redeem their points/award. The consumer may also be offered the opportunity to redeem the points/award in whole or in part until they expire. If the consumer wants to redeem them all at one time he or she may be capable of doing so through the loyalty and reward program.

The loyalty and reward program may track all discounts and breakage from the failure to redeem awards/points. This may allow the provider to share such with users, such as the breakage that may occur 90. Further, the loyalty and reward program may track all elements of codes, including pricing, discounts and breakage. Reports may be generated by the loyalty and reward program, automatically or manually. Any sharing of discounts or breakage may be performed through the loyalty and reward program.

Once the award/points have been assigned to a consumer, the consumer may be required to create a membership with a user name, such as their email and password. The consumer may create such credentials when they first log on to the loyalty and reward program and after they enter their validation code. However, if a consumer who is a participant in the loyalty and reward program through several users, and uses the same user name (such as their email), the loyalty and reward program may require the use of URLs for each user to associate the applicable consumer's membership with the applicable user. This may allow for better tracking of the awards, redemptions, and may allow for production of reports with more accurate information.

The loyalty and reward program may ask consumers, such as at the time such consumers initially log in to opt in or out of marketing messages, such as from the user or provider. The loyalty and reward program may also provide informational alerts to indicate the available benefits to opt-in to the marketing messages. Once logged into the loyalty and reward program, the consumer may redeem the award for products, services and the like.

After logging off and fully redeeming the award balance consumers may log back onto the applicable loyalty and reward website again. However, unless they have a balance in their account they may have limited functions available, such as being limited to just special promotions offered from time to time.

The provider may format the loyalty and reward program such that they may or may not charge a set up fee or license fee initially. Further, the loyalty and reward program may present a set up and license fee, but may allow the provider to waive such for some predetermined period, such as a predetermined initial period from instigation of the loyalty and reward program for a user.

The user may benefit from a more effective awards process and eliminate the issues surrounding plastic gift cards and the selection of gifts. The loyalty and reward program may also limit IT involvement issues that other online reward programs encounter. By way of a non-limiting example, identified information may be pushed to the loyalty and reward program and the platform of such may take this information and apply it appropriately within the loyalty and reward program. There may be no need to embed the platform of the loyalty and reward program into a user's IT system but rather just have data pushed to the provider or the loyalty and reward program. Further, the loyalty and reward program may use an API to establish common logins to keep it simple for users.

The loyalty and reward program may also provide benefits to the consumer. For consumers that have lost an award certificate email and the award certificate, the user—or more specifically, the user manager—may be able to pull the original email and hit “resend.” The consumer may then have access to the applicable award certificate and may be able to redeem the otherwise lost award/points. Further, a consumer may have a home page created, either manually by the provider or user or automatically by the loyalty and reward program. The consumers may then check their balance of awards/points on their own home pages. Consumers, however, may also be able to check balances under a predetermined section of the loyalty and reward program, e.g., a “My Gift Codes” section, where gift codes they have redeemed from their points will be listed with a code and PIN.

The loyalty and reward program may be customizable in that it may be capable of providing a branded site for a user instead of using standard loyalty and reward program base website. The loyalty and reward program may provide for such customizations to be made online.

The loyalty and reward program may be used with any kind of incentive program. It may be used as part of employee benefits programs, residential leasing programs, consumer purchase programs, and any other appropriate system. It should be understood that the present teachings are not limited to any particular use. The loyalty and reward program may be used for any sort of incentive program. Further, any portions of the loyalty and reward program may be used and the features described below and above may be expanded or truncated without departing from the present teachings. Functions may be excluded or additional functionality added without departing from the present teachings.

Additional embodiments of a loyalty and reward program according the present teachings are described below. In the descriptions, all of the details and components may not be fully described or shown. Rather, the features or components are described and, in some instances, differences with the above-described embodiments may be pointed out. Moreover, it should be appreciated that these other embodiments may include elements or components utilized in the above-described embodiments although not shown or described. Thus, the descriptions of these other embodiments are merely exemplary and not all-inclusive nor exclusive. Moreover, it should be appreciated that the features, components, elements and functionalities of the various embodiments may be combined or altered to achieve a desired loyalty and reward program without departing from the spirit and scope of the present invention.

In some exemplary embodiments, the loyalty and reward program may facilitate the creation and complete customization of an employer's associate's rewards program. In these embodiments, the employer may be capable of earning a return on the investment on the employer's incentive budget.

The loyalty and reward program may be customized to recognize and reward employee/associates for achieving a desired behavior identified by each employer. Associates may be awarded points instead of cash or gift cards for events such as: anniversaries, employee of the month, customer service, employee surveys, training goals, sales goals, and any other internal performance objectives. Associates may be able to redeem their awarded points for whatever they want, whenever they want at merchants participating as part of the loyalty and reward program. Associates may be capable of getting ‘dollar for dollar’ value. The employer, however, may actually reduce its costs to participate in the incentive program—reducing its overall incentive budget.

The loyalty and reward program may provide an automated web-based platform that is capable of awarding and keeping track of points. The loyalty and reward program may also enable associates to redeem points for electronic gift certificates and may provide the employer with a comprehensive communications tool with complete branded messaging capabilities that may generate program results in real time.

The loyalty and reward program may provide an FTP report interface to transfer information from the employer database to the provider. The rewarding of points to associates may be automated, done manually or a combination of both. The FTP reports may be automated and transfer program data generally seamlessly with a predetermined frequency. Some examples of reports that can be transmitted via FTP are: new hires, terminations, promotions and anniversaries.

The loyalty and reward program may not require any personal information of the employer or associate or require maintenance of such personal information. The loyalty and reward program may only require the following information from the employer for the applicable associate: property identification, employee identification, first/last name, e-mail, job title, hire date and termination date.

The loyalty and reward program may allow each employer to determine its own budget. The appropriate budget may be based upon many factors, such as the employer's specific program needs. Budget dollars may then be allocated into the loyalty and reward program as applicable. As noted above, an initial deposit may be required equal to the anticipated monthly program spending. In addition, the employer may be billed monthly based on the points awarded in the previous month. The invoice may be sent via email through the loyalty and reward program by the provider, or may be sent under a separate e-mail.

Further, the loyalty and reward program may provide an ancillary revenue opportunity for the employer's current incentive budget. The loyalty and reward program may generate ancillary revenue such as by associates redeeming points for promotional codes used to purchase products from predetermined merchants. The provider may, as part of the loyalty and reward program purchase promotional codes from certain merchants at a discount. The provider may share in the discount savings with the employer. In addition, it is not uncommon for consumers to allow their points to expire, which is called breakage. Industry statistics show on average approximately 35% of consumers let their points or gift cards expire. Under the loyalty and reward program the provider may share breakage of the associates with the employer.

Further, the loyalty and reward program may allow the employer to effectively and efficiently manage such. By way of a non-limiting example, the loyalty and reward program may be managed by a generally centralized department manager—the department managers may view or be authorized to make changes to all associates in the corporate office and any applicable satellite locations, or as otherwise authorized. Further, the employer may appoint a regional/district manager and the regional/district manager may view and be authorized to make changes to all associates in his or her assigned region, or as otherwise authorized by the employer. The loyalty and reward program may be customized upon program set-up or later—specifically the management may be tailored to each employer's specific needs. Additionally, the loyalty and reward program may allow the employer to manage its incentive program at the corporate level as well as by specific business units or other smaller units.

The loyalty and reward program may be implemented by the provider for the employer in any appropriate manner. By way of a non-limiting example, the implementation steps may include the following: sign user agreement, identify program name and applicable URL, design custom branded website, determine program budget, management team sets up program template, program manager assigned, IT-FTP report integration tested, image link placement on corporate website, marketing and training developed, and program rollout.

Employers may also be capable of branding the loyalty and reward program platform with their own messaging, creative and program an appropriate URL. The loyalty and reward program may be used to create and produce custom PDF or HTML marketing pieces that introduce and promote such program. Print marketing collateral design and production may also be provided. The loyalty and reward program may also facilitate the creation and complete customization of the employer's rewards program as required or otherwise applicable.

Further, in other embodiments of the loyalty and reward program such as one used in multi-family residential complexes, the loyalty and reward program may be designed to recognize and reward residents for achieving the desired behavior identified by each landlord, i.e., it may be customized as necessary. Residents may be awarded points with a redeemable cash value to purchase whatever they want, whenever they want at participating merchants. Residents may get ‘dollar for dollar’ value, while costing the applicable landlord less.

The loyalty and reward program may provide a fully automated web-based platform that awards and keeps track of points; enables residents to redeem points for electronic gift certificates; provides a comprehensive communications tool with complete branded messaging capabilities; and generates program results in real time. In some embodiments, including the web version thereof, an FTP report interface may be used to transfer information from the landlords' database to the provider. The rewarding of points to residents may be automated, done manually or a combination of both. FTP reports may be automated and transfer program data seamlessly with a predetermined frequency.

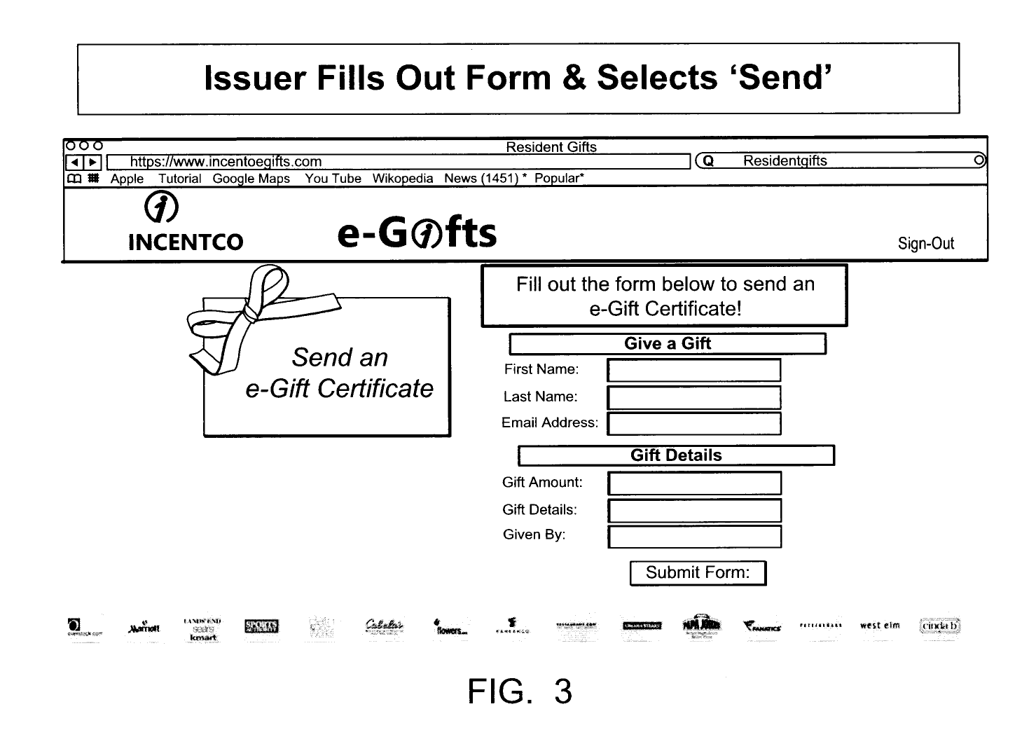

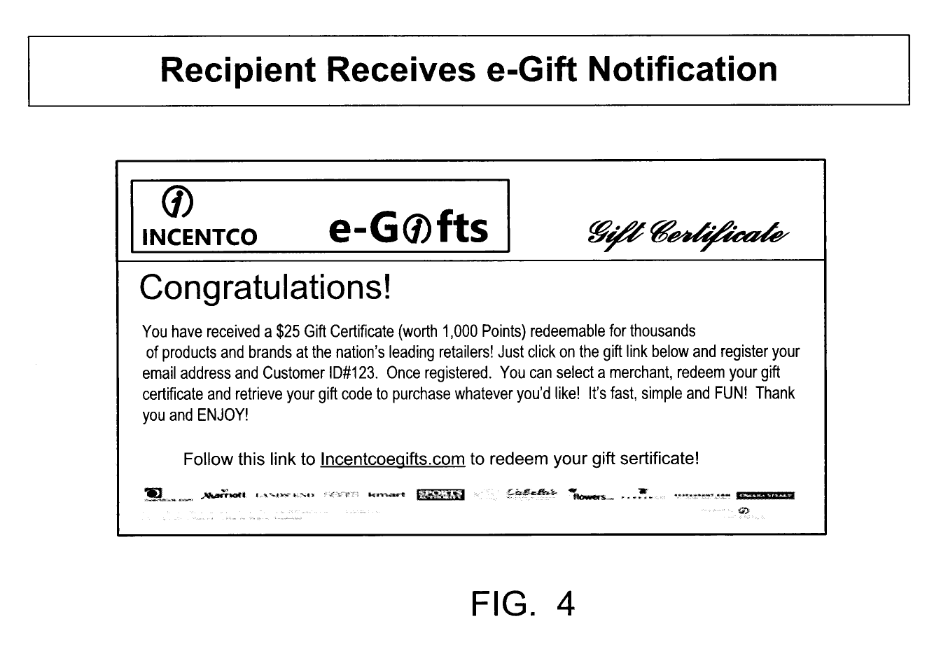

Regardless of the field of use of the loyalty and reward program, an exemplary embodiment of the website is shown in FIG. 2. Under this embodiment, an issuer—whether it is a property manager, employer or the like—may provide a gift as an incentive to reward a specific occurrence or event. The issuer may log into the gifting website of the loyalty and reward program—see FIG. 2. Once logged in, the issuer may complete, either manually or automatically, a form with the relevant information as may be necessary to send the e-gift certificate—see FIG. 3. The recipient will then receive an e-mail notification of the gift provided by the issuer—see FIG. 4.

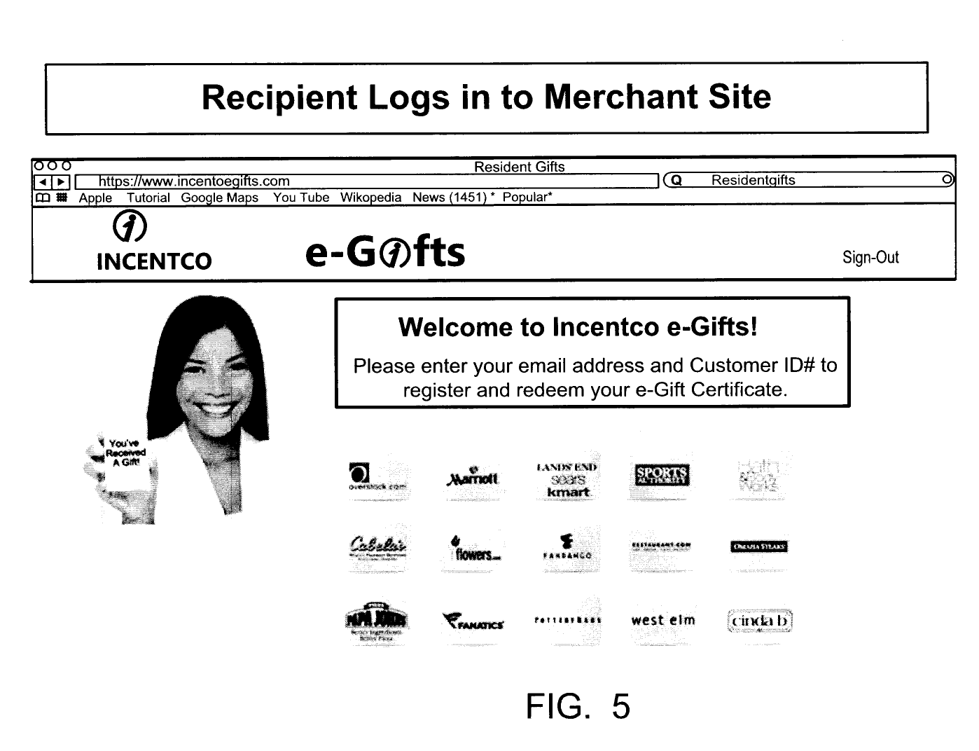

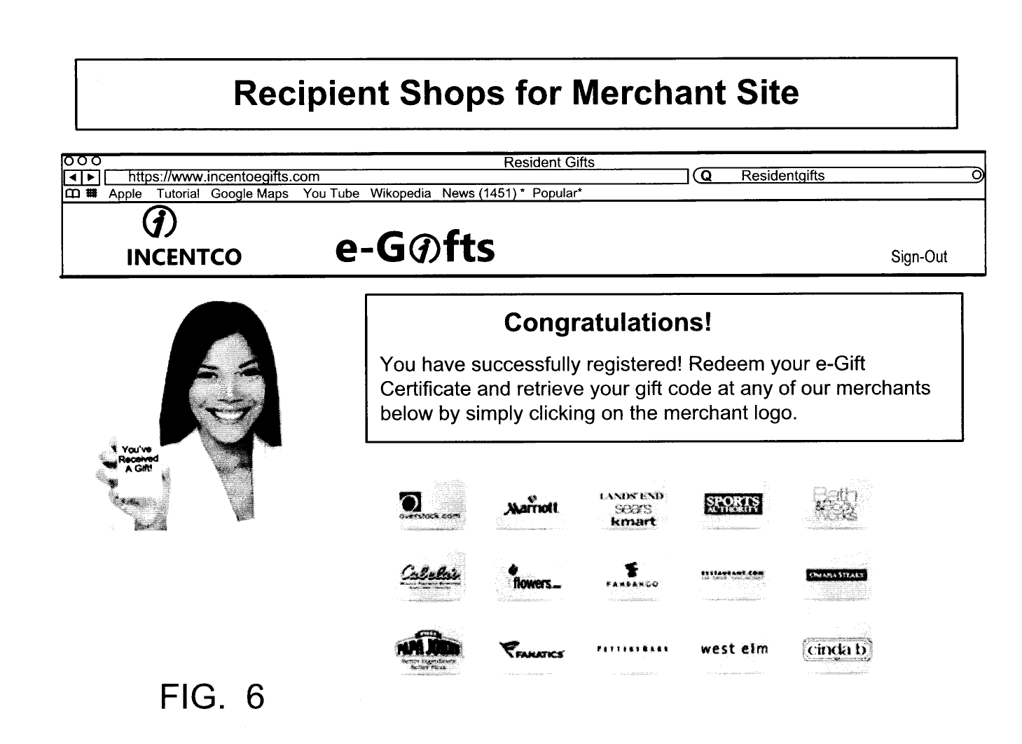

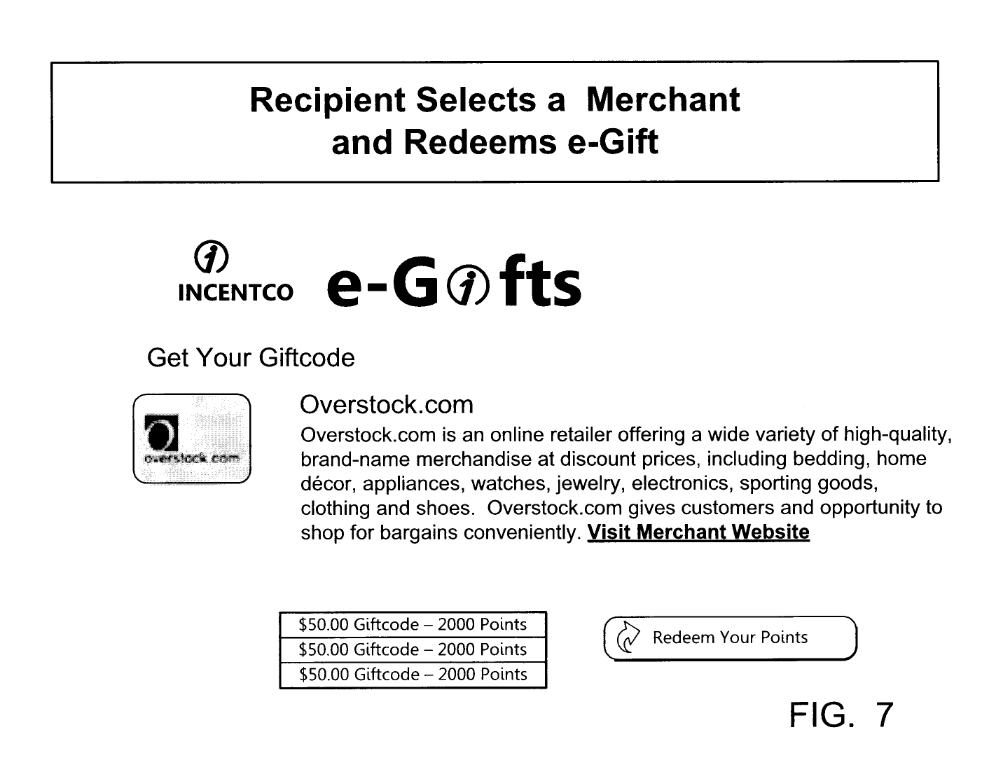

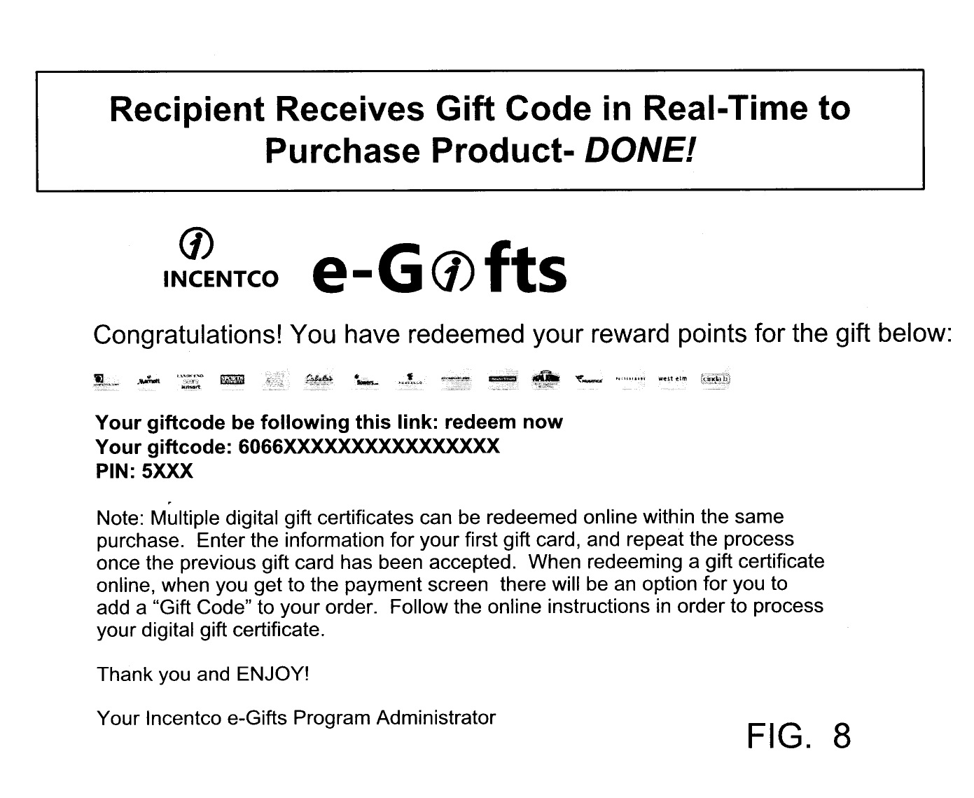

The recipient may then log into the merchant website, such as by entering his or her applicable identification—see FIG. 5. Upon logging-in, the loyalty and reward program may validate the login information to ensure that such person is authorized to log in under the credentials entered. The loyalty and reward program may also confirm the point award balance award available to such recipient, enables the review and selection of available gift code inventory and may deliver communications regarding certain activities. The recipient may then shop for merchandise, services or the like on the applicable website—see FIG. 6. The recipient may then select an applicable merchant and redeem the e-gift—see FIG. 7. A notification may then be sent to the recipient with the applicable gift code so that the recipient may be able to redeem the e-gift for actual goods, services or the like—see FIG. 8.

The following are further exemplary embodiments of the loyalty and reward program. The present teachings are not limited to the specific embodiment set forth above. Variations and alterations are within the scope of the present teachings. The loyalty and reward program may be used with multi-family real estate market, such as residential apartment buildings or complexes. In such embodiments, the apartment community may be set-up in the loyalty and reward program, which may provide personalized portals for both the community and individual residents to manage the program. A one-time set-up fee may be collected or monthly license fees may be collected, or both.

Existing apartment residents may be automatically enrolled and then emailed a link to the applicable website containing the loyalty and reward program to incentivize the resident to activate their account by setting their passwords. Upon activation of the account, residents may be able to accrue rewards, such as points, offered by their property manager as part of predetermined activities, including, without limitation, move-in incentive, move-in gift, referring a new resident, renewing the lease, paying rent on time, resolving a conflict or other events as determined by the property manager. The residents may find local or national merchants as well as service offers from their apartment community on the loyalty and reward program.

The property manager at the property may use the loyalty and reward program portal to award points to residents for events specified by the owner/property manager that normally would call for an incentive. By way of a non-limiting example, in the program $1 may equal 40 points or the points may be awarded on a manual basis. Points may be awarded at the time of an applicable event, e.g., move-in, referral, conflict resolution, etc., or as a batch at week or month end. Additionally, the loyalty and reward program may award points based on a resident or consumer's physical location. The loyalty and reward program may use a GPS based QR or geo code that may be assigned to the resident or consumer. The loyalty and reward program may analyze this geo code and based upon information provided to the loyalty and reward program a predetermined award point may be applied for the particular residents/consumers based upon their location.

The residents may redeem their award points for promotional codes that may be used to purchase goods and services at nationally recognized brand-name merchants or for services offered and provided by their apartment community. The residents may gain access to a third party or affiliate's shopping website such as through the loyalty and reward program website, which may provide merchandise at attractive discounts on apartment focused goods and services. Under the loyalty and reward program, the resident is able to select the product or services that he or she wants, further providing an incentive to the resident. The resident is not left to accept a gift he or she does not otherwise want.

Specifically, when a resident chooses to redeem his or her points, the resident may log on to the loyalty and reward program website and go to his or her personal home page. The loyalty and reward program will check and confirm the validity of the log on information, i.e., does the user name and password match the applicable resident. The resident may select a merchant and redeem his or her points. After making such selection, the resident may receive a promotional code via email equal in value to the points redeemed. As part of the loyalty and reward program, the provider may pay less than the face value for the promotional code, generally achieving a 10%-20% discount, some of which may be shared with the property manager. After the resident receives the promotional code he or she may conclude the transaction with a direct purchase through the merchant's website.

If points are not redeemed by a pre-selected day after the termination of the resident's lease, the points may expire. If the resident is evicted or not in good standing at time of point exchange, he or she will not be eligible to receive or redeem points. For residents that remain in good standing, points will expire on a pre-selected date, such as at the end of the year following the year in which the points were awarded, which may provide at least twelve months to redeem points unless there is an earlier termination of the lease.

The provider may charge a one-time set-up fee—this is a fee paid by a property owner to the provider to set-up a property on the platform. This fee may vary depending upon the level of integration required with the property manager and the platform. Further a monthly license fee may be due—this is a fee paid monthly by a property manager to access the platform and use its features. The property manager may pay the provider monthly via ACH debit, electronic fund transfer or credit card. This could be paid at the beginning of each month or annually for a small discount.

Property managers may award points at any appropriate ratio, such as by way of a non-limiting example, at a ratio of 40 points per $1 to the resident throughout the month. The provider may establish with each property manager the annual budget by property for total point awards and property manager may pay the provider a deposit of approximately one month of budgeted point awards. At the end of each month the provider may invoice the property manager for the actual total of points awarded during the month. At the end of each calendar quarter, the provider may send statements on actual points awarded by property manager on a per property basis. The statements may include and payment will be made to the property manager for the credits due for the discount rebate and expiration rebate.

The provider may purchase promotional codes from the targeted vendors at discounts, generally from 10%-20%. These codes may be delivered to users when they redeem their points. For services offered and provided by the property manager a discount may be applied. The provider and property manager may calculate the total value of the discounts achieved on a property basis at the end of each quarter and may share in the revenue.

Further, the property managers may share on a pro rata basis in commissions generated and paid to the provider on an affiliated website. The property manager does not have to enroll in the core provider program to offer this discount program but an additional share in the commission may be payable if the property manager also offers the provider rewards program. The commissions generated from the property manager's website may be tracked directly. In some cases where the property manager is a part of a pool of several property portfolios the property manager's share may be based upon the total number of property units as a proportion of the total units active on the affiliated website.

The loyalty and reward program has utility for property owner/managers of both a single property and multiple properties. Such property owners may own or manage a portfolio of properties. As such, the loyalty and reward program may be used with a portfolio and may provide additional management features for administering an incentive program for employees, residents, and other contributors. The loyalty and reward program may be a web-based program accessible through any Internet connection. The loyalty and reward program may include a home page that includes certain pre-defined links that may allow the user to link through the loyalty and reward program to perform the applicable function. Set forth below are exemplary embodiments of these link. It should be understood, however, that these are merely exemplary embodiments and are not exhaustive examples and are not intended to limit the scope of the present teachings.

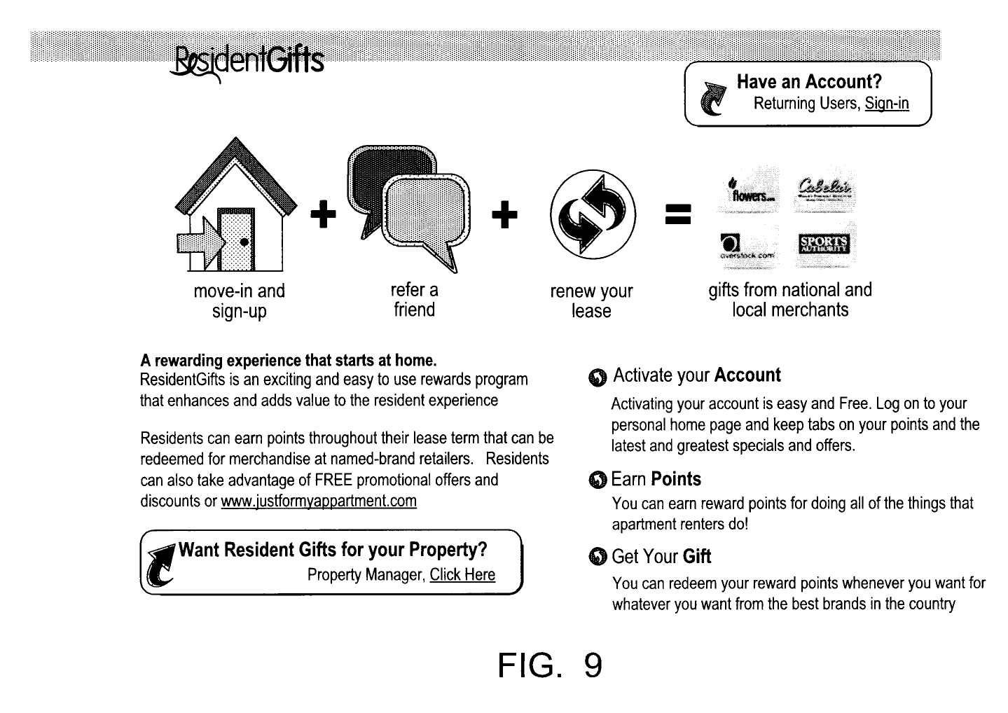

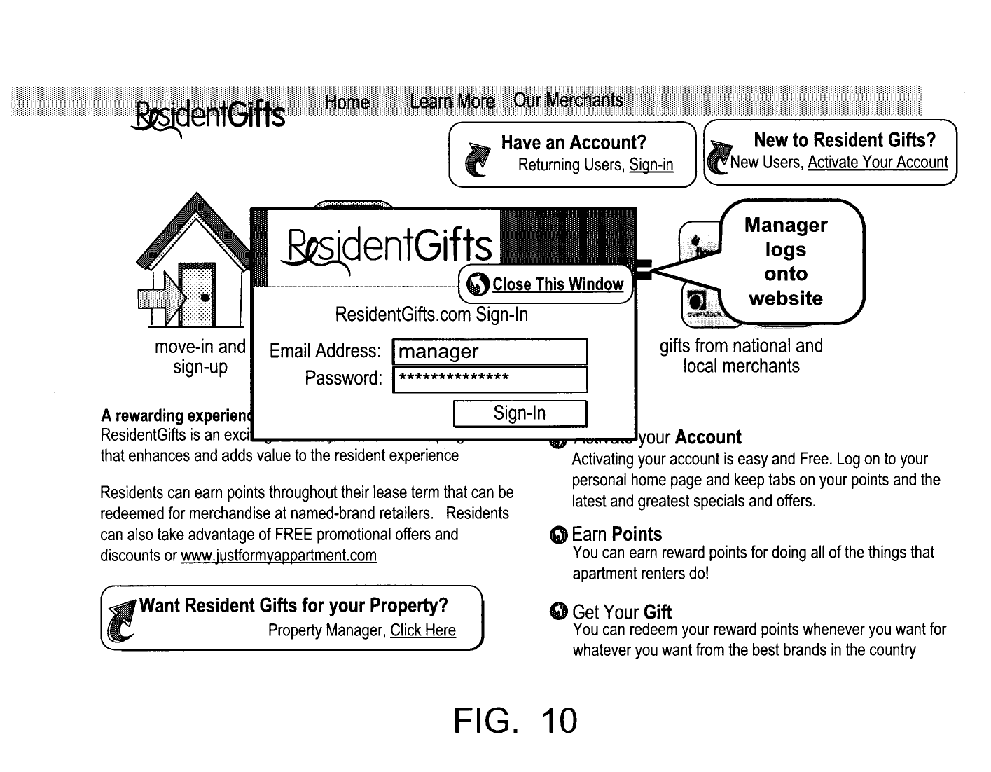

A user of the loyalty and reward program, such as the regional manager, may access the home page of the loyalty and reward program, an example of such is shown in FIG. 9. The manager may log on to the loyalty and reward program through a link on the home page. The login may provide a secure environment for the user so that others may not access the information contained in the loyalty and reward program for that particular user. The information maintained therein may be secure and generally protected from viewing by others. An example of a login page is shown in FIG. 10.

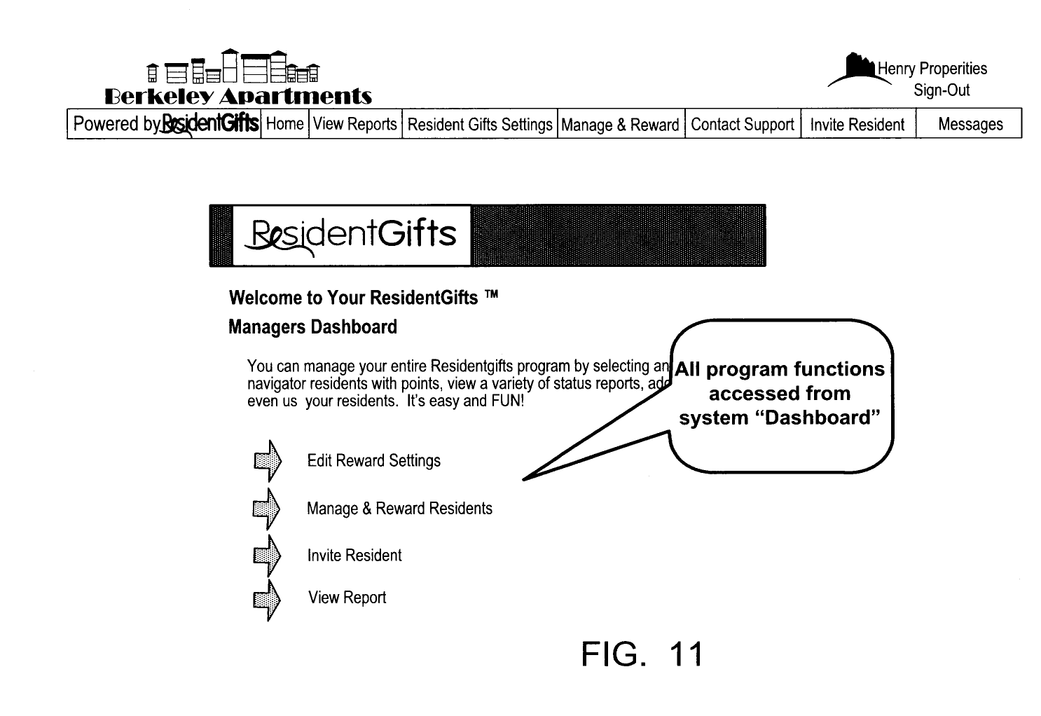

The loyalty and reward program may include a dashboard of commands and functions. The user may access these commands and functionality through the dashboard. The user may click the applicable link and the loyalty and reward program will open the appropriate window for the user to use and access. An example of the dashboard is shown in FIG. 11.

The loyalty and reward program may manage an entire portfolio of a property owner. A portfolio may contain a single property or thousands of properties depending on the business model at hand. The portfolio may be a collection of properties and regions. The portfolio may also include reports, invoices, and maps of management relationships for the portfolio, its properties and regions. Users of the loyalty and reward program at the portfolio level may manage administrative issues through the entire organization and have ultimate authority to control all other system users including, without limitation, region managers, property managers, employees and residents.

The portfolios may contain at least one default region. If no specific name is given, the default region may reflect the name of the portfolio. The primary purpose of a region may be to allow for segmentation of accounts payable/receivable and user level access. Region manager level users may access all properties assigned to their region and may also manage more than one region. The applicable property may be assigned to a region and may be managed by any appropriate levels of users, such as: portfolio managers, region managers, and property managers. It may be possible to restrict the fields that may be edited by a particular user, such as the property manager should the organization have varying policies on the authority level granted to its property management staff.

The portfolio may be a link located in the loyalty and reward program. A user may click a link to view an index of all portfolios to which the user has access. The user may view, create and delete portfolios from the loyalty and reward programs. To add a new portfolio, the user may click the appropriate link with the loyalty and reward program. This may bring up a portfolio creation wizard tool within the loyalty and reward program. The user may enter the type of the portfolio, e.g., a single property or a portfolio of properties. The user may then enter the portfolio's name and the loyalty and reward program may default to add new properties therein. Next the user may choose the portfolio owner and enter the portfolio's website, if there one exists. The user may then select the default property type, one or more management teams, and one or more optional inventors. The user may then click the finish button, which may create the portfolio. This may complete the process of creating a portfolio.

To view the portfolio's details, the user may double click the applicable portfolio in the index of portfolios. This may take the user to the portfolio's details page. A portfolio may also be deleted. In such embodiments, the user may select the applicable portfolio from the index of portfolios. The user may then click the delete portfolio button.

A user may also export the list of portfolios or information related to the portfolios to another file, such as a CSV file. By way of a non-limiting example, the user may click an export button whereby the CSV file may contain the names, contact people, phone numbers, fax numbers, cities, states, and websites of the portfolios—or any other appropriate information. The files may be exported to any appropriate file type to be read by any appropriate software program. The information may then be manipulated, sorted, and analyzed as necessary.

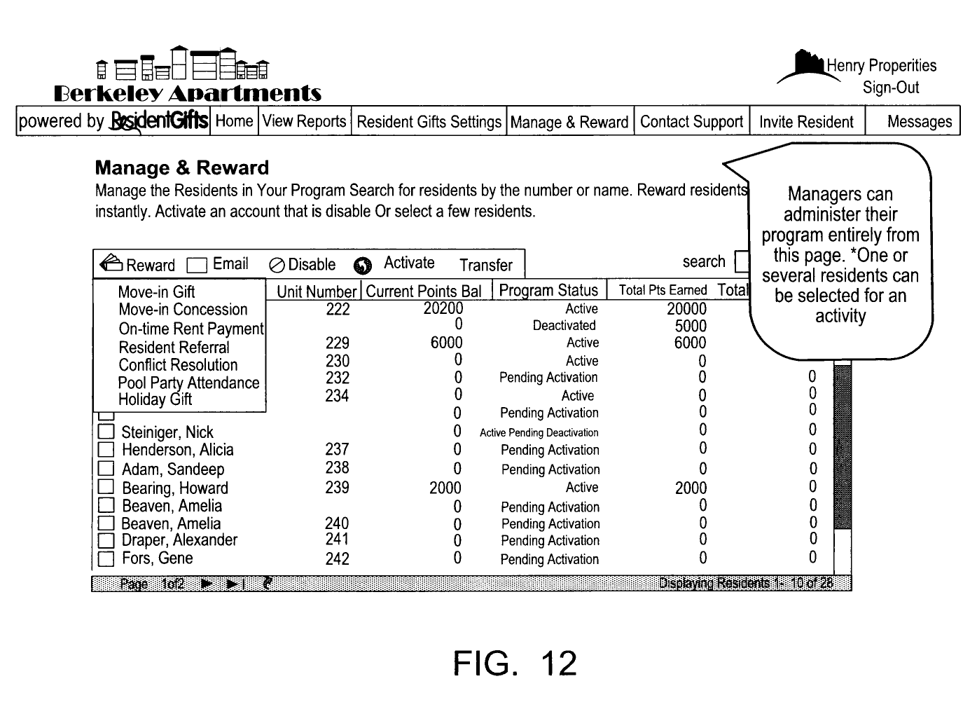

The loyalty and reward program may include tabs that may allow a user to edit and save the particulars of a selected portfolio. This may include basic information, contact information, management teams, investors, the logo and billing information. The tabs may be of any appropriate design and may be at any appropriate location on the loyalty and reward program. Further, the user may administer the entire loyalty and reward program from predetermined webpages of the loyalty and reward program, an example of such is shown in FIG. 12.

The loyalty and reward program may include any appropriate logo, such that of a user, participant, customer, or the like. The applicable logo may be uploaded onto the loyalty and reward program in any appropriate manner. By way of a non-limiting example, the logo may be uploaded as a GIF, JPG, or PNG file or the like. The logos may also be deleted or edited within the loyalty and reward program as appropriate.

The loyalty and reward program may further allow a user to assign management to portfolios, regions, and properties. A portfolio may have multiple management teams, and only the management team members of the assigned management teams may be available to the applicable portfolio. The user may also remove an assigned management team from the portfolio's list in any appropriate manner.

The loyalty and reward program may allow the user to create a new investor therein so that the information may be accurate and update-to-date. To do so, a user may select an appropriate button on the loyalty and reward program website, such as one stating, “add owner/investor.” Once selected a pop-up window may appear such that the user may complete the form and add the relevant information for the investor into the loyalty and reward program. The user may then save the information to the loyalty and reward program. The user may also assign an already existing owner/investor in a similar fashion. Similarly, the user may remove an owner/investor as well.

The loyalty and reward program may allow a user to add and remove existing managers from the portfolio or for a specific property. To assign a manager, the user may select the appropriate button, e.g., add existing manager. The user may then add from an existing list of available managers or may manually add a manager by inserting the relevant information. The user may then select to save the information. Following a similar process, the user may remove an existing manager. The user may select the appropriate name to remove. A button may then be selected, such as the “remove existing manager” button. Once selected the manager's name will be automatically removed from the index of property managers. The information may then be saved or may be downloaded or exported to a file, such as a CSV file.

The managers may also comprise a list of team members. The applicable team members may be added to the management team by selecting the button “add new team.” A pop-up window may appear so that the user may complete the applicable information and save the information. The user may add an existing team member from a previously created list or may manually add the team member in the applicable field. The user may also disable an existing team or team member. The user may select the applicable team or team member and may select the delete button. The information may then be saved and such team or team member may be removed or otherwise disabled from the loyalty reward and program. It should be understood that any previously disabled team or team member may be enabled in a similar process. This information may be exported to a file, such as CSV file.

A property or a plurality of properties may be added to a portfolio or portfolios of the loyalty and reward program. The user may select an add property button. A window may open that may allow the user to insert the information necessary to create the property or properties within the applicable portfolio. The user may then save the information. Once this information is added, a user may select a property from the list of properties available. The full details of the property may then be shown. The details may include basic information, contact information, inventors, logos, parameters, and any other appropriate information. The user may be able to make changes to the information as necessary. The user may select the applicable property and amend the applicable information within the loyalty and reward program. By way of a non-limiting example, the user may upload unit numbers for a particular property. The user may upload the applicable information, such as through the use of a CSV file. The applicable file may include the property identification, the unit, address, city, state and zip code. A report may be generated providing the applicable information.

The loyalty and reward program may also manage invoices. By way of a non-limiting example, invoices may be listed by date. The user may select the applicable invoice and the loyalty and reward program may access and display the appropriate information of the invoice. The user may also access additional information on any applicable invoice such as by selecting the invoice. Upon selection of the applicable invoice, the information related to the invoice may display through the loyalty and reward program. The user may manipulate this information, print it, download it, export it, or e-mail it to others. By way of a non-limiting example, the loyalty and reward program may include a button that may allow a user to select an invoice and an e-mail is automatically generated that includes the applicable invoice information. The user may either add the e-mail address manually or may select it from a list. Once selected or added, the user may send the e-mail with the applicable invoice attached.

Further, the loyalty and reward program may include an internal message center that may auto-generate e-mails to both resident's and external e-mails. The auto-generated e-mails may include welcome invitation to register an account, account activation confirmation, awards notification, marketing subscription confirmation and any message generated manually by the manager.

The loyalty and reward program may also allow a user to conduct an audit, such as an audit of the awarded points by region and timeframe. The user may select the appropriate dates of the audit, such as through the use of a calendar. The user may then select the region to be audited. The results of the audit may be exported to a file, such as a CSV file. The information downloaded may include the award name, date of award, reward note, points awarded, dollar value, to whom it was awarded, and from whom the award came.

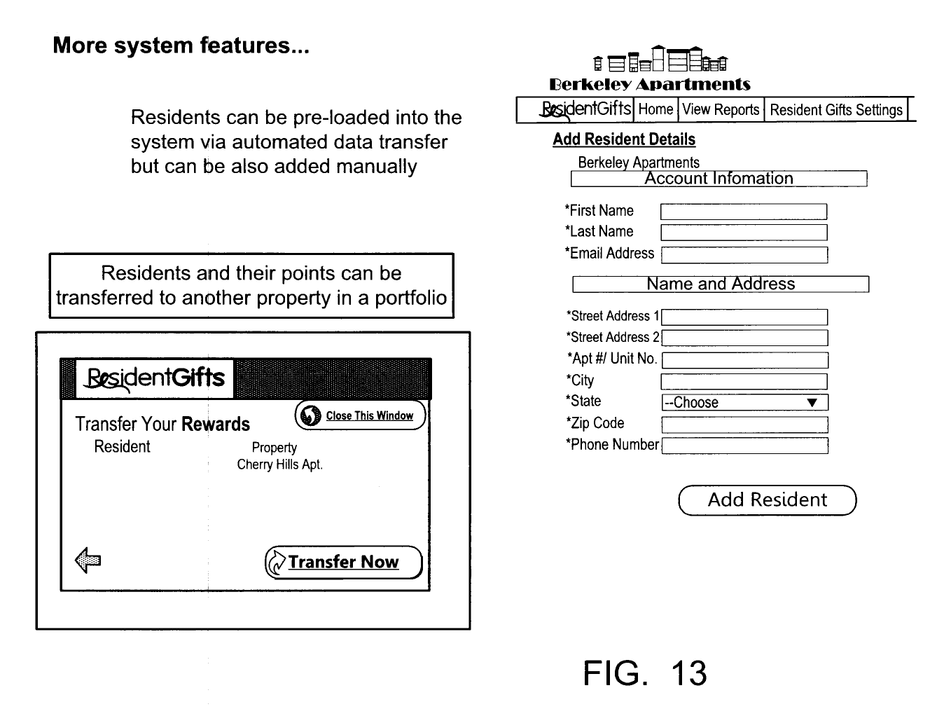

When a new resident signs a lease, the user may enter such resident into the loyalty and reward program. The user may select the appropriate unit number and then select a button such as “move in existing resident.” This may bring up a pop-up window with the available residents. The user may select the appropriate resident and add him or her to the applicable unit. Alternatively, the user may manually enter the new resident's information. An example of a screen-shot of such from the loyalty and reward program is shown in FIG. 13. The user may follow a similar process to move out an existing resident. The user may select the unit number and then may select the button “move out current resident.” The resident's name will then be removed and the unit will be emptied so that a new resident may be added. Additionally, the resident information may be uploaded from a separate file. This may allow multiple residents to be applied to the specific unit in which they reside. The file may contain the following information: property identification, resident identification, first name, last name, unit, address, city, state, zip code, e-mail, move-in date, and the like. Once the applicable file is uploaded, a report may be generated with the applicable information. The applicable information may also be exported to a file, such as a CSV file.

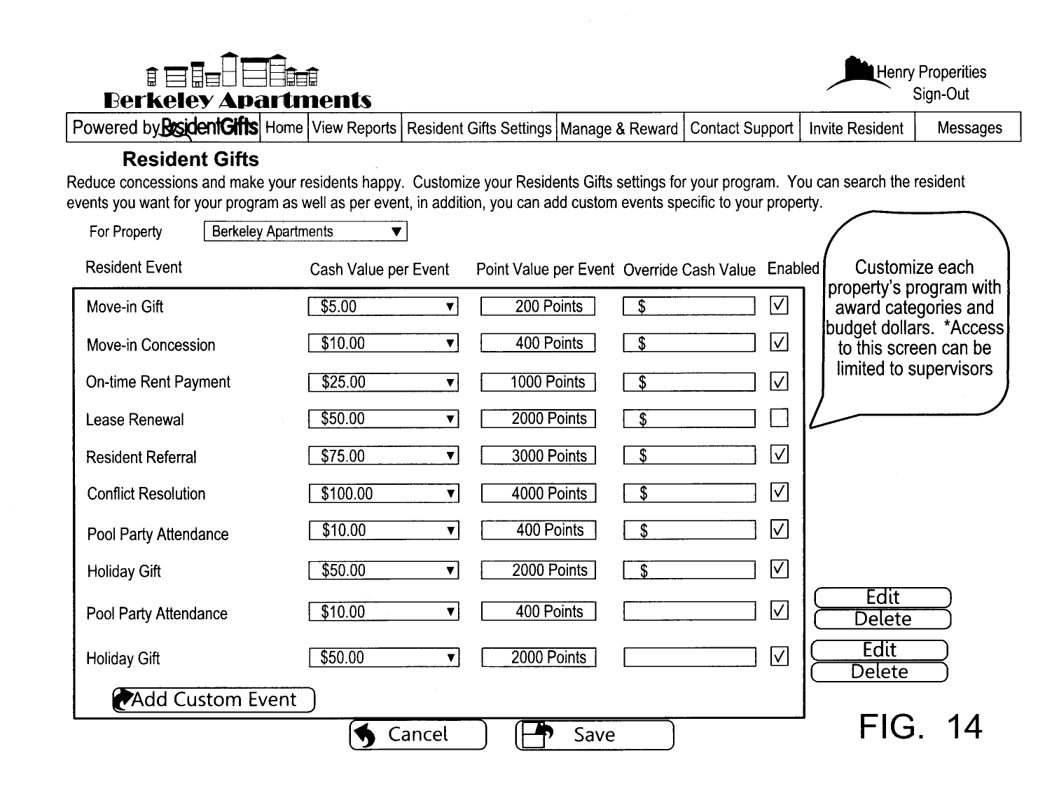

A budget may also be created from the loyalty and reward program. The budget may be created by selecting the appropriate button, e.g., the create budget button. A pop-up window may appear that includes relevant information, such as the applicable years of the budget. The user may select the appropriate year or month. The user may then save the information and the budget may be associated with an index of the applicable property. The user may edit the budget by selecting the appropriate budget from an applicable list. Once selected the appropriate information may be added, deleted or amended as necessary. The user may then save the information. Moreover, the loyalty and reward program may permit the user to customize each property within the portfolio with award categories and budget dollars. The user with an applicable authorization may enter the loyalty and reward program. Upon entering, the user may select program setting. A screen may pop-up whereby the user may enter the applicable information, an example of which is shown in FIG. 14. It should be understood, however, that the user may enter any customized information for a specific property. The information is not limited to award categories and budget dollars.

The loyalty and reward program may allow a user to create a gift basket for the property and link or unlink it with an event. A gift basket may be a container for gift codes. Once the gift basket has been created, it may be assigned to an event, e.g., a lease renewal, referral, or the like. If the event is awarded to a resident, the resident may be given access to at least one gift code from the gift basket. In order to create a gift basket, the user may select the button “create basket.” Once selected a pop-up window may appear. The user may then complete the necessary information and may be saved. Once completed, the gift basket may be added to the index of gift baskets.

The user may link the gift basket to an event through the loyalty and reward program. To link the indexed gift basket, the user may select the desired gift basket from the index. The user may then click “link to event” button. This may bring up a pop-up window that includes the available events. The user may select the applicable event and tie it with the applicable gift basket. The information may then be saved. The user may also unlink an event from the gift basket. The user may select the desired gift back from the index of gift baskets. The user may then select the “unlink from event button.” Once selected, a pop-up window may appear with the applicable list. The user may then select the desired event from the list. This information may then be saved.

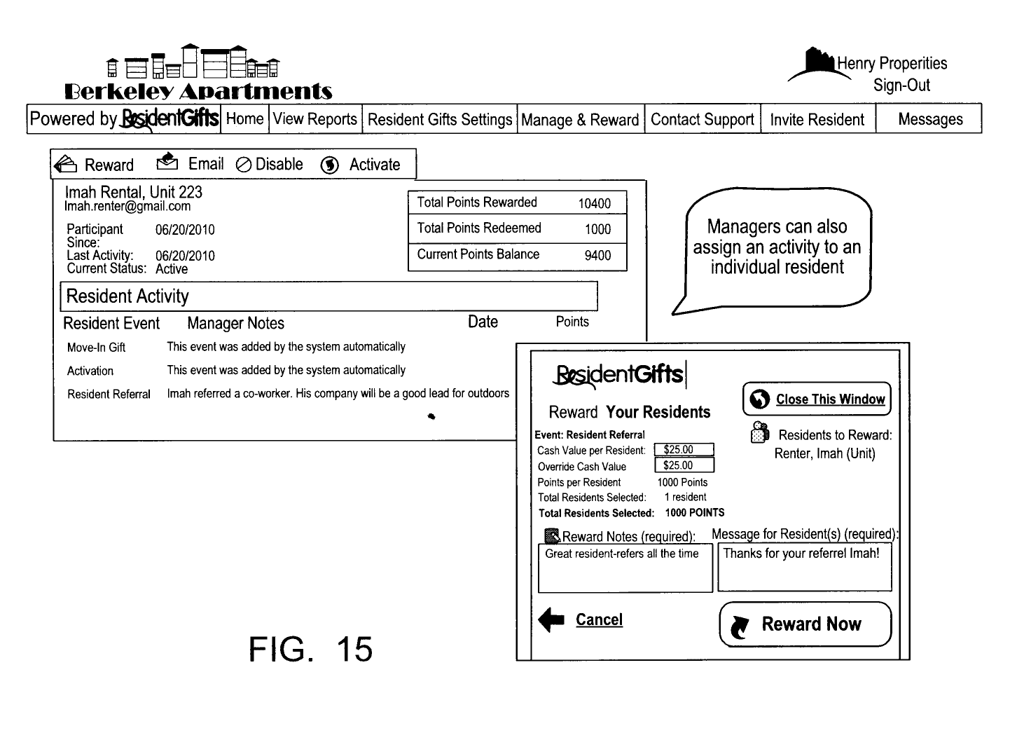

The loyalty and reward program may further permit the user, such as the manager or administrator, to assign an activity to a resident, an example of which is shown in FIG. 15. The user may select the appropriate link within the loyalty and reward program. A pop-up window may appear and the user may enter the applicable information. Once entered, the information may be saved within the loyalty and reward program. The information entered may then be tied to the applicable resident.

A user may also add a gift code to an applicable gift basket within the loyalty and reward program. To add a gift code to an applicable gift basket, the user may double-click the desired gift basket in the index of gift baskets. The user may then add an existing code to the gift basket, such as through selecting “add existing code” button, which may bring up a pop-up window. The user may then select the applicable supplier and code from the list. The information may then be saved. To remove an existing code, the user may first select the code in the index of gift codes. Then the user may click the “remove existing code”. When this is complete, the index of gift codes will update to remove the gift code selected.

The loyalty and reward program may include an index of property-specific suppliers. The user may add a new supplier and upload an applicable inventory. To add a new property supplier, the user may select “add new supplier” button. This may bring up a pop-up window with fields to be completed. The user may complete the available fields with the applicable information and may save the form. The user may also upload new inventory from a file, such as a CSV file. The user may create the file with at least the following information: supplier name, supplier code, date of purchase, date of redemption, redemption value, cost basis, discount by dollar or percentage, sku value, code format, code, pin format, pin, and duplicate verification or the like. Once created, the user may select the button “upload inventory” and the applicable file and the relevant information therein may be uploaded into the loyalty and reward program. The information may then be saved and a report with the applicable information may be generated.

The loyalty and reward program may also allow logos to be uploaded whereby the logo may be associated with the applicable supplier. Further, the user may add a single code through selecting the button “add single code.” Once selected a pop-up window may open with available fields to be completed. The user may complete the applicable information and save the same within the program. The user may also export the information added as described above within a CSV file or any appropriate type of file. The user may select the “export page to CSV” button and the information will be exported to the applicable file in a predetermined format.

The loyalty and reward program may also include a lead capture module. The lead capture module may provide an index of leads captured from the form of the main page. The user may select the lead for reviewing and editing such as by double-clicking such lead. The user may also export the lead information to a file, such as a CSV file.

The loyalty and reward program may provide certain relevant accounting information. The user may export a report to CSV of the applicable income information, which may allow the user to manipulate such information or use such information for accounting records and audits. This information may assist the property owner/manager to perform audits and pay applicable taxes. The loyalty and reward program may also include a journal report, which is a report of several types of income in summary form on a monthly basis for accounting purposes. The information may be provided by month and year. The user selects the applicable month and year and a report may be processed containing the relevant information for the user. The information may be exported to a CSV file.

The loyalty and reward program may also include an FTP importer. The user may import at least the following types of CSV file templates: resident move-in, resident move-out, and notice to vacate. The results may be displayed and an exception report may be generated and sent to an e-mail address listed in the FTP importer configuration section. In addition, the user may manually import the files for move-in, move-out and notice to vacate reports.

The loyalty and reward program may also allow for creation and use of communication templates. The communication templates may be used to drive, reinforce or incent certain behaviors. Moreover, the user may add things such as the applicable terms and conditions to which a user, resident, customer, or the like may be required to agree to in advance of using the loyalty and reward program. Further, the loyalty and reward program may allow for creation of marketing communications, general informational communications and the like. Such communications may be sent to managers, users, leads and the like.

Once the user has completed his or her tasks with respect to the loyalty and reward program, the user may logout of the program. Another user may then utilize the loyalty and reward program. Similarly, multiple parties may be capable of logging in to a single loyalty and reward program to perform these tasks.

In some exemplary embodiments, an apartment management company may pay the provider of the loyalty and reward program a predetermined percentage of its allocated incentive budget at the beginning of each month. At the end of each quarter, the provider may complete the reconciliation. For example, if the management company granted $1,500 in incentives in the quarter whereby they paid a total of $2,250 for such quarter, it would be entitled to a $750 refund. If the management granted $3,000 in incentives for the quarter, it would be required to make an additional $750 payment. As part of the reconciliation, the provider may calculate the revenue due to management from discounts and breakage, such as from the failure of an award of points to be redeemed. Management will receive a quarterly rebate check based upon discount and activity and breakage, such as through the loyalty and reward program, or may receive a credit within the loyalty and reward program equal to such amount.

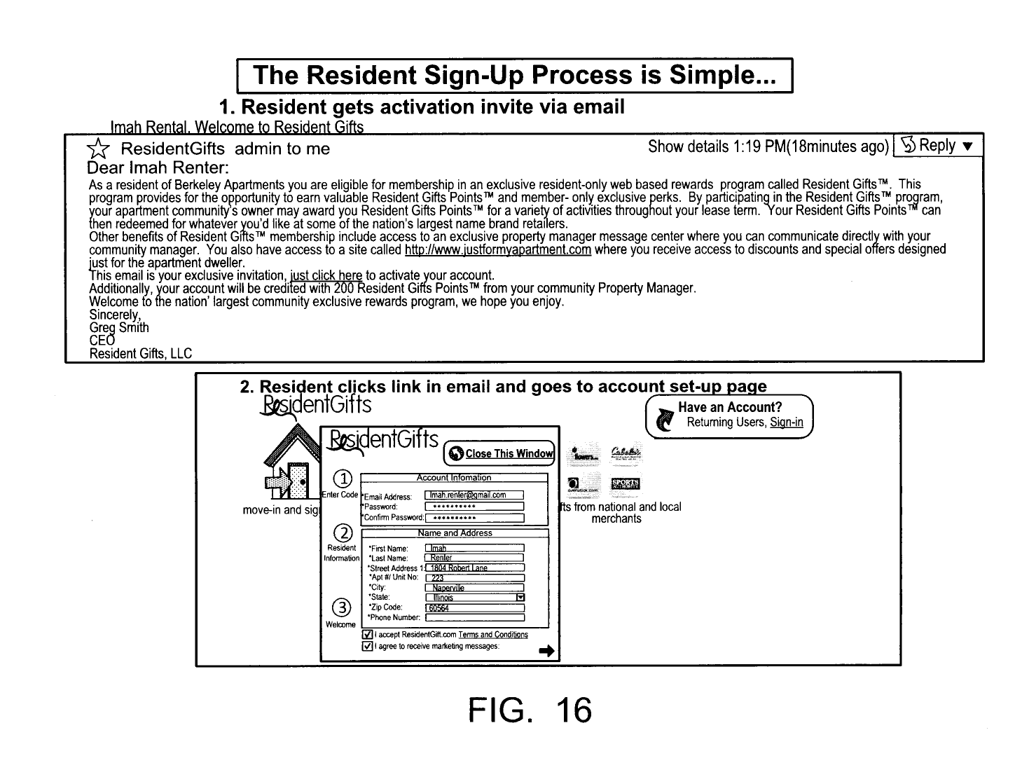

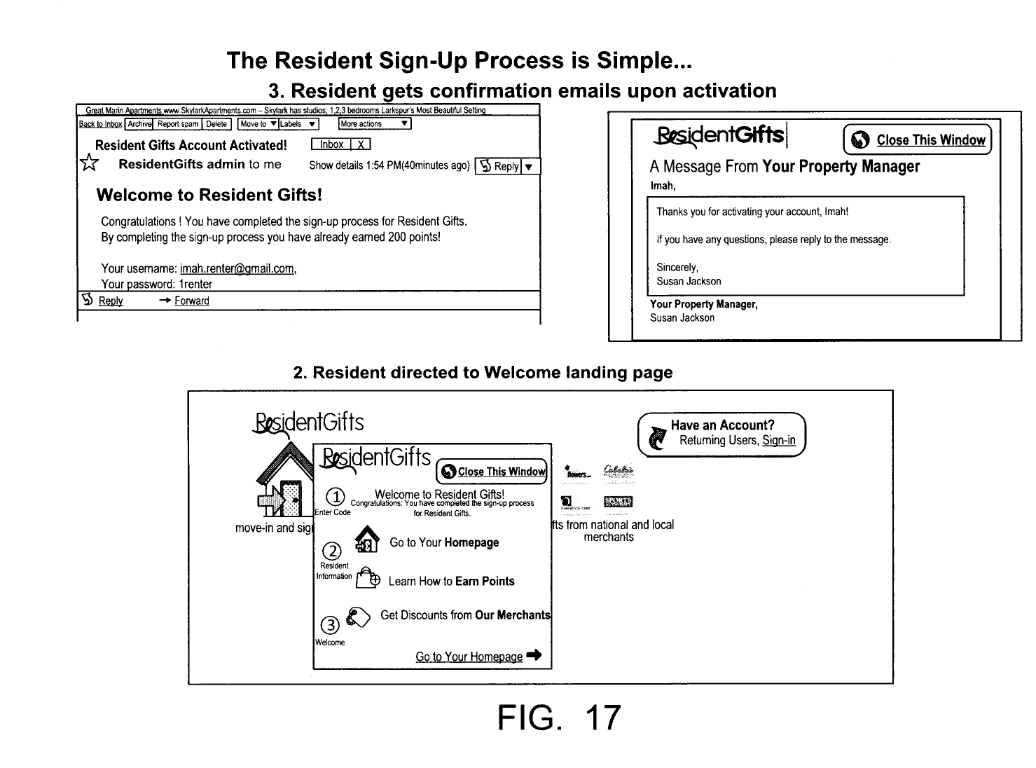

As part of the loyalty and reward program, residents may be enrolled within the loyalty and reward program. The resident may receive via e-mail an activation invitation. The e-mail may contain a link to the applicable website containing the loyalty and reward program—see FIG. 16. Upon activation of the account, residents may be directed to a welcome landing page, such page may contain relevant information about the loyalty and reward program for the resident. The resident may also receive a confirmation e-mail upon activation. The confirmation e-mail may contain additional information for the resident—see FIG. 17.

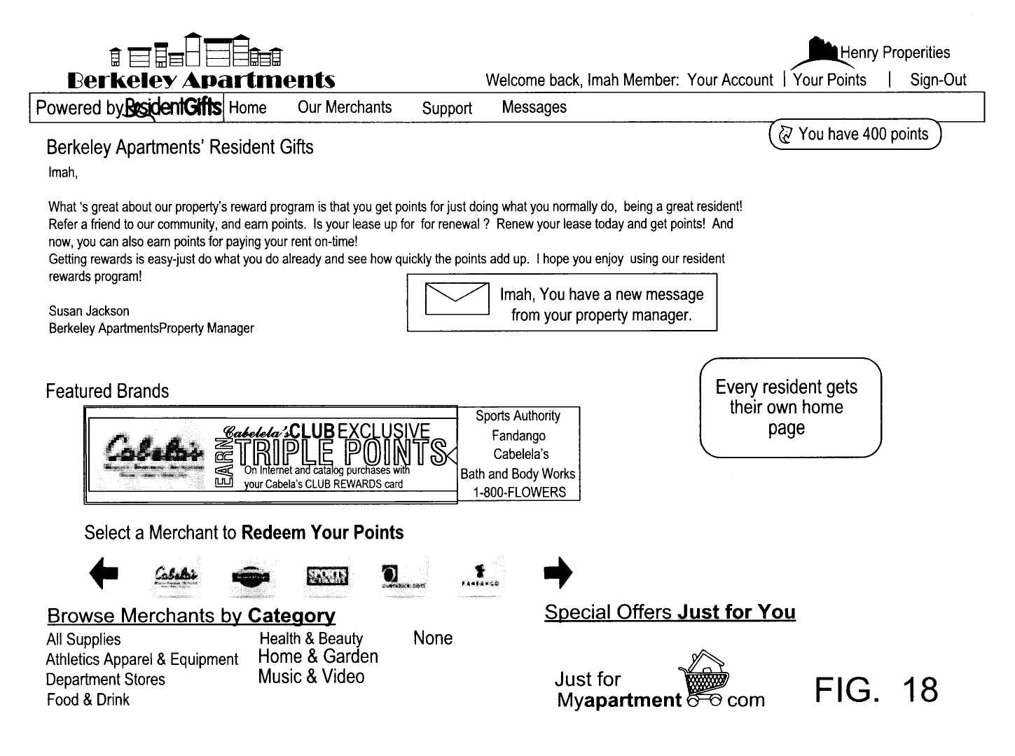

Each resident may have his or her own resident home page—see FIG. 18. The home page may contain information relevant to the resident. This may include information about award accruals, general property information, lease information, or any other communication that the property manager/owner may wish to provide the resident.

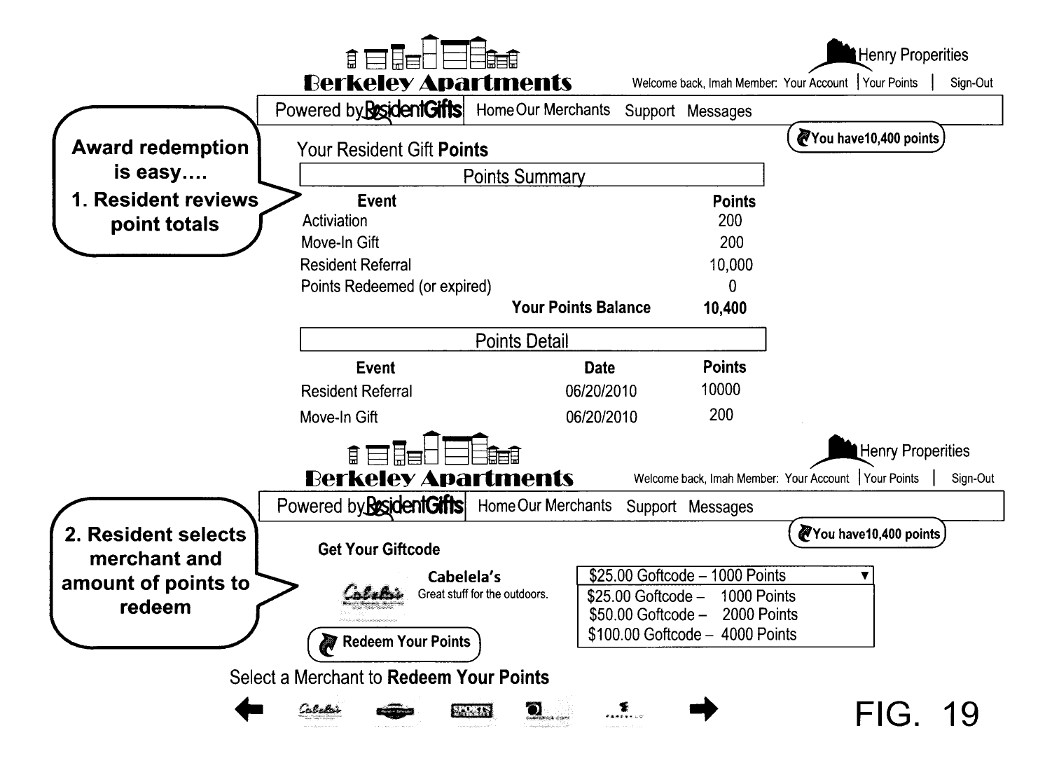

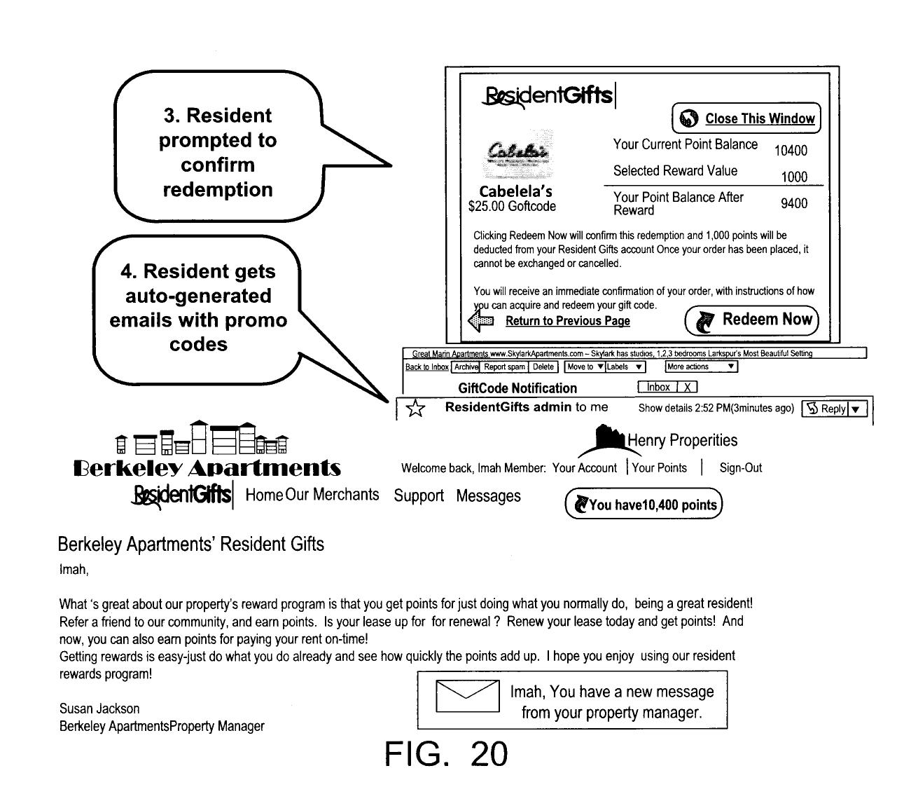

The residents may redeem their gift points for promotional codes that may be used to purchase goods and services. When a resident chooses to redeem his or her points, the resident may log on to the loyalty and reward program website and go to his or her personal home page. The resident may review his or her point total. The resident may then select a merchant and the amount of points to redeem—see FIG. 19. After making such selection, the resident may then be prompted to confirm the redemption. Once confirmed, the resident may receive a promotional code via email equal in value to the points redeemed. The loyalty and reward program may generate an automatic e-mail sent to the resident with the promotional code so that the resident may conclude the transaction with a direct purchase through a merchant's website—see FIG. 20.

In some embodiments, the loyalty and reward program may be used as part of employee incentive programs. Points may be awarded for leasing performance, customer service, anniversary dates, special promotions, etc. Both ancillary revenue components may apply, so the user may earn ancillary income while employees may receive dollar for dollar reward value.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter.

The claims as follows are intended to include all modifications and alterations insofar as they come within the scope of the claims or the equivalent thereof.

Having thus described the invention, we claim:

1. A method of providing rewards to a first party, the method comprising the steps of:
providing a loyalty award Internet website;
purchasing a plurality of promotional codes, wherein the plurality of promotional codes are redeemable from a plurality of merchants;
storing the plurality of promotional codes within the loyalty award website;
allowing an award to be granted to the first party by a second party through the loyalty award website, the award having a preselected amount, wherein the first party may obtain at least one of the promotional codes stored in the loyalty award website, whereby an amount of the promotional code obtained is related to the amount of the award;
automatically generating a notification to the first party from the loyalty award website, wherein the notification includes a link to the award; and
allowing redemption of at least a portion of the amount of the promotional code through the loyalty and award program.

2. The method of claim 1, wherein the second party is a residential property manager or landlord.

3. The method of claim 2, wherein the first party is a resident of a multi-family residential property.

4. The method of claim 1, wherein the second party is an employer or manager of the employer.

5. The method of claim 4, wherein the first party is an employee of the employer.

6. The method of claim 1, further comprising the step of allowing purchase of the award by the first party through the loyalty award website.

7. The method of claim 6, further comprising the step of paying the second party a predetermined portion of any of the award not redeemed by the first party.

8. The method of claim 1, further comprising the step of redeeming at least a portion of the gift code for at least one of a product, service, gift card, or cash by the first party.

9. The method of claim 1, further comprising the step of automatically generating a report from the loyalty award website of the awards granted by the second party to the first party.

10. A method of providing rewards to a user, the method comprising the steps of:
accessing a loyalty award Internet website by a first party;
making an award to the user by the first party through the loyalty and reward website; and
notifying the user of the award; and
allowing access to a plurality of promotional codes stored within the loyalty award website; and
allowing redemption of the award for at least one of the plurality of promotional codes through the loyalty award website.

11. The method of claim 10, wherein notifying the user of the award includes automatically generating an email sent to the user from the loyalty award website.

12. The method of claim 10, further comprising the step of entering information regarding the user and the first party by uploading the information into the loyalty award website from a file.

13. The method of claim 10, further comprising the step of purchasing the award through the loyalty award website by the first party.

14. The method of claim 10, further comprising the step of receiving payment by the first party of a predetermined portion of any of the award not redeemed by the user.

15. The method of claim 10, further comprising the step of generating at least one report and making it accessible to the first party, wherein the report provides information about the award granted.

16. A method of providing rewards to a user, the method comprising the steps of:
providing a loyalty award Internet website;
acquiring a plurality of promotional codes;
storing the promotional codes within the loyalty award website, wherein the plurality of promotional codes are redeemable from a plurality of merchants;
providing access to the loyalty award website by a first party;
permitting the first party to make an award to the user through the loyalty award website, wherein the award is redeemable by the user for at least one of the promotional codes; and
providing an alert to the user to redeem the award for the at least one of the promotional codes through the loyalty and award program.

17. The method of claim 16, wherein the alert is automatically provided through the loyalty award website.

18. The method of claim 16, wherein the first party is an employer providing a benefit program.

19. The method of claim 16, wherein the first party is at least one of a property manager or landlord of a multi-family residence.

20. The method of claim 16, further comprising the step of providing access to the loyalty award website for the user to redeem the award for the at least one of the promotional codes.
